(19) United States
(12) Patent Application Publication
(10) Pub. No.: US 2004/0195226 A1
(43) Pub. Date: Oct. 7, 2004

(54) Electrothermic membrane with metal core

(76) Inventor: Aldo Stabile, Crema (IT)

Correspondence Address: Striker Striker & Stenby, 103 East Neck Road, Huntington, NY, 11743, US

(21) Appl. No.: 10/480,914

(22) PCT Filed: Feb. 25, 2002
(86) PCT No.: PCT/IT02/00110

(30) Foreign Application Priority Data
Jun. 20, 2001 (IT) MI01U000336

(51) Int. Cl. H05B 3/28

(52) U.S. Cl. 219/213; 392/432

(57) ABSTRACT

Membrane (20) with a metal core (21) for waterproofing and generally protecting structures (80) for housing and infrastructures, consisting of only one or of several components, presenting very high electrical conductivity, entire lengths or parts thereof, thickness and width being constant to obtain, on closure in an electric circuit (92, 93, 97, 98) of all or part of said core (21), transformation of electric energy into thermal energy therefore adding, by an association of thermal and mechanical effects, the advantages of generation of heat to those of protection and waterproofing.

The invention concerns means for heating, waterproofing and generally protecting structures for housing and infrastructures.

The various sorts of bitumens in common use are mixtures of hydrocarbons having a high molecular mass and being of a semi-solid or solid consistency; they are found in the natural state or obtained by processing crude mineral oil to produce tar for bitumen asphalt or bitumens for industry.

These latter are at present used to make membranes that are particularly useful for waterproofing foundations, for paving in contact with damp ground such as found in cellars, to prevent rising damp in semibasements and basements, subgrade foundations for hanging gardens, for laying underneath roofs, as a thermo-insulating layer under flat or curved roofs, for train and road tunnels, hydraulic works under ground, for waterproofing in bathrooms, saunas, kitchens, refrigerating rooms, waste dumps, the floors of canals and reservoirs, generally speaking wherever problems arise concerning waterproofing or prevention of rotting.

To improve efficiency and adapt them according to needs, these membranes can also be made of plastic materials or can be associated to elastomers, plastomers or to other mechanical components such as metal lamina cores, mineral fibres, fiberglass, continuous-thread polyester netting, or netting made of metal or of other materials.

Membranes with a metal lamina core can advantageously be of a thickness from 2 to 4 mm, that of the lamina itself being a few microns.

The above invention offers very considerable improvements on such products, increasing efficiency and making them of universal utility, all this being done by extremely simple and inexpensive means, as will here be explained.

Subject of the invention is a membrane having a metal core to be used for waterproofing and generally protecting housing structures and also infrastructures.

Consisting of one or more components, this core possesses extremely high electrical conductivity over some or the whole of its length, thickness and width being constant so that, on closing the electric circuit of all or part of said core, electric energy is transformed into thermal energy thus adding, by association of mechanical and thermal factors, the production of heat to its qualities of protection and waterproofing.

In one advantageous application the membrane consists of bitumen; this can be associated to plastomers and to elastomers.

The metal core is preferably made of copper or of aluminium.

In one execution the core is laid as a continuous serpentine by means of parallel cuts in the whole membrane or in the metal core only, extending alternatingly from one edge to within a short distance from the opposite edge.

The cuts can be made crosswise or longitudinally.

The components of the metal core are placed side by side so as to cover the area to be protected, series or parallel connected to the source of electricity.

The metal core and its various components are connected to the source of electric current by means of a regulator or electronic processor to program and render automatic, in one area of the membrane or in parts of it, the values of temperature and heating times to suit environmental conditions.

Electrical connection to the metal core is made by exposing points of electric contact, in the material that covers the metal core, using chemical and mechanical means for this purpose.

In one execution the membrane is laid under the flooring, of tiles or any other material, of indoor rooms.

In one execution the membrane is laid under airport runways.

In one type of execution the membrane is laid under paving of roads, in the open or in tunnels, and of airports.

In one type of execution the membrane is laid under the outer roofing of buildings.

In one type of execution the membrane is laid under the earth in which are embedded plants to form the grassy surface of football stadiums.

Thickness of the membrane is preferably between two and four millimeters while applied power is comprised between 20 and 100 Watt per m².

Thickness of the metal core is preferably 20-40 microns.

The metal core can be formed of rectangular or of U-shaped square components, laid side by side and adequately spaced for electrical insulation.

For each metre of metal core one metre wide, voltage of 0.5 to 1 V can advantageously be applied and current from 20 to 100 A.

The invention offers evident advantages.

The protective characteristics of present membranes are here associated to the basic advantage of heat, well known to be a decisive factor in protecting structures and infrastructures at present in use.

Heat not only improves mechanical protection as well as that against damp, for which plastic materials and bitumen, whether or not in conjunction with plastomers or elastomers, are used, but also offers a pratically universal and inexpensive means of protection against adverse climatic factors such as ice and snow.

Generation of heat by electricity, allied to means ensuring a very high level of efficiency, can be regulated and electronically programmed in a simple and timely manner.

To sum up these advantages, the passive membranes at present used can be applied to an enormously increased field by adding such easily adjustable and programmable means of furnishing heat.

Characteristics and purposes of the invention will be made still clearer by the following examples of its execution illustrated by diagrammatically drawn figures.

FIG. 1 A role of bituminous membrane strip with a serpentinewise transversal aluminium core formed by cuts in the core, perspective.

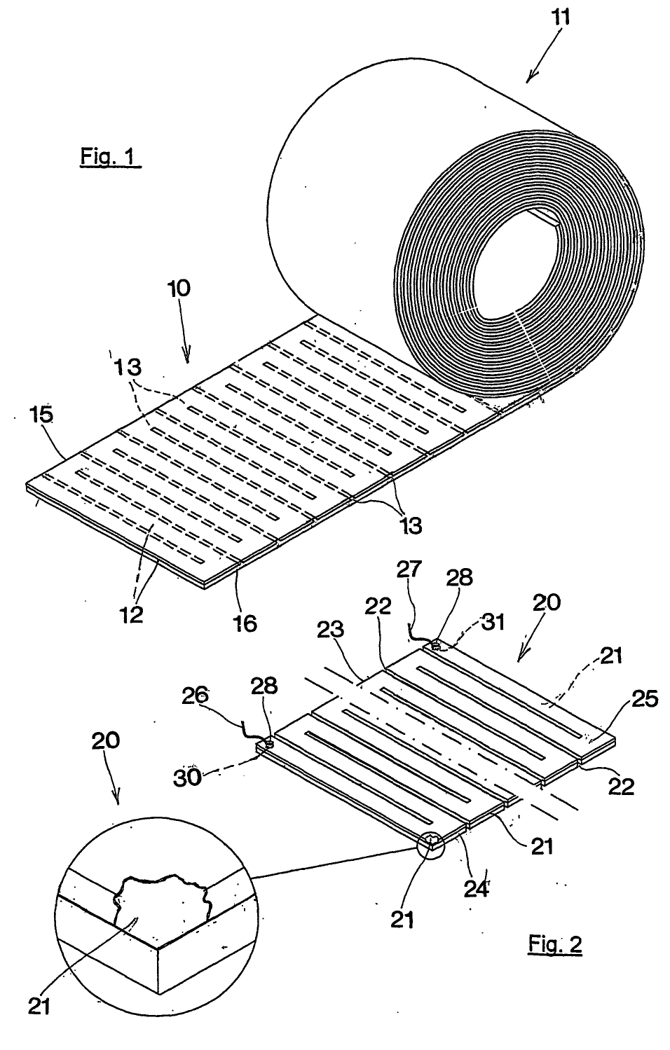

FIG. 2 A bituminous membrane with serpentinewise aluminium core obtained by crosswise cuts in the membrane, perspective.

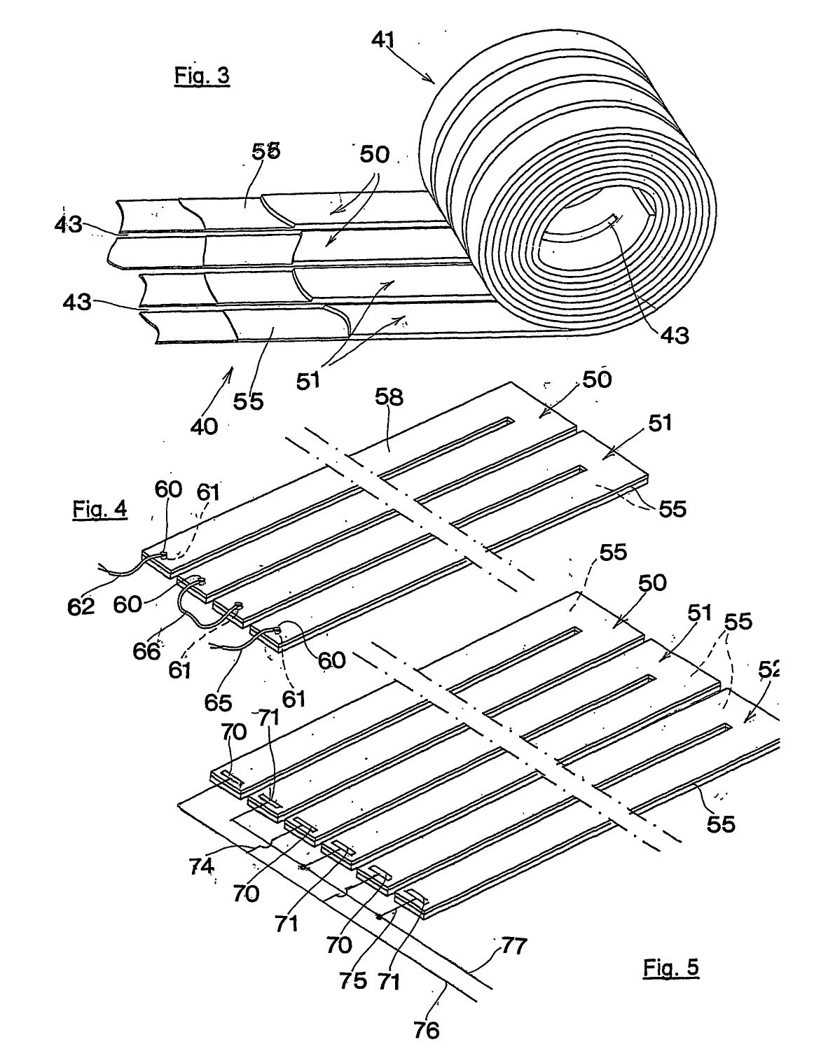

FIG. 3 A role of bituminous membrane strip, with aluminiuim core, formed of longitudinal U-shaped components, perspective.

FIG. 4 The U-shaped components in FIG. 3 electrically connected in series, perspective.

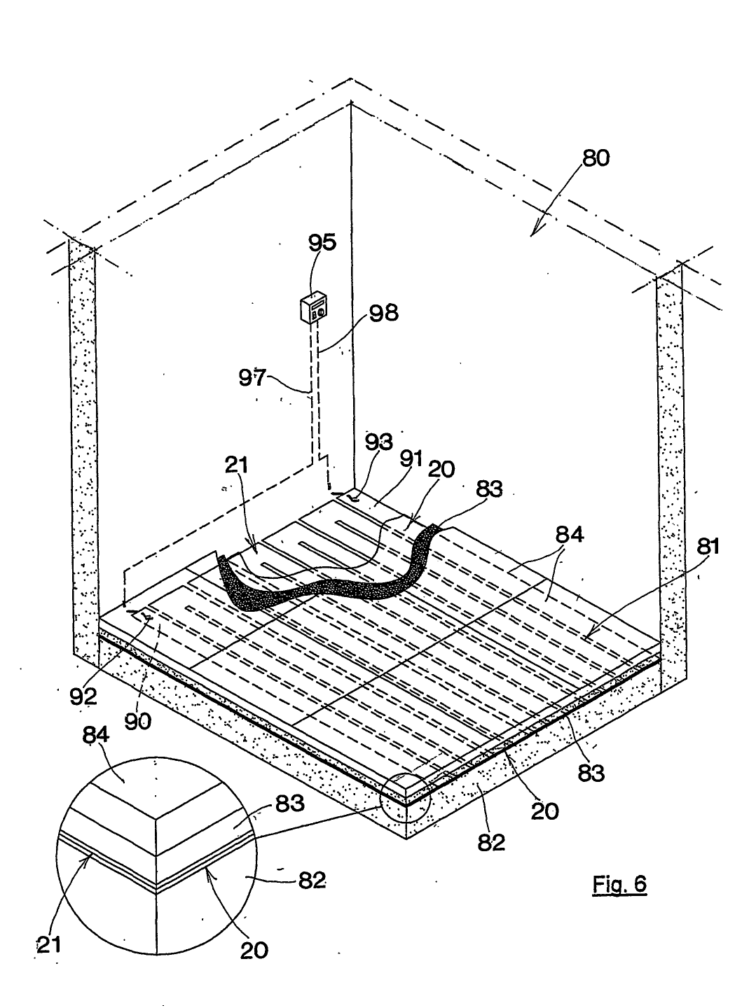

FIG. 5 The U-shaped components in FIG. 3 electrically connected in parallel, perspective.

FIG. 6 Room in a house with electrically heated floor using the bituminous membrane, perspective cut through.

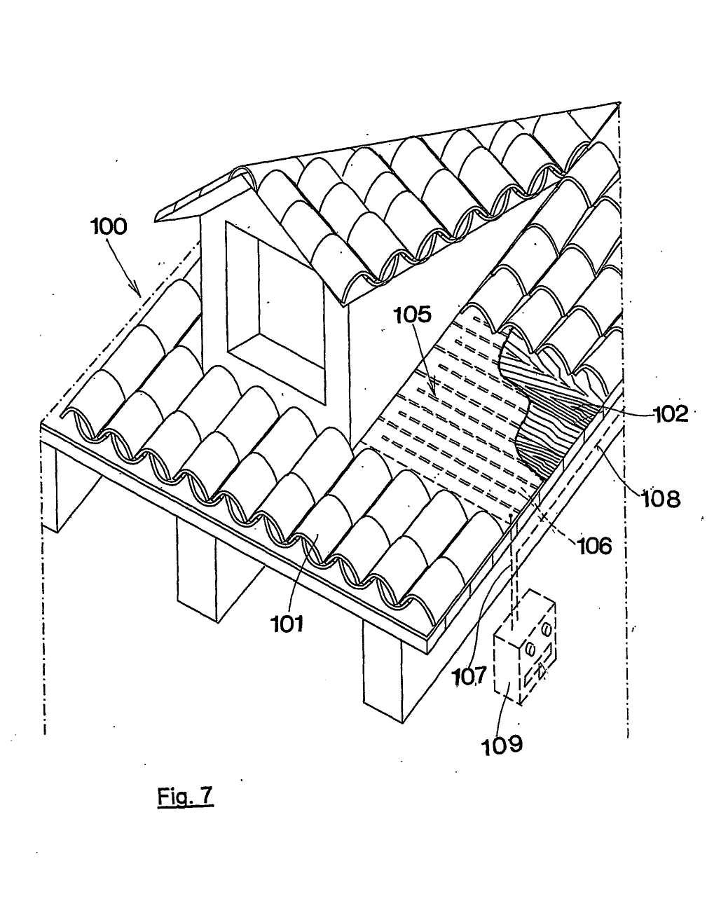

FIG. 7 A roof electrically heated using the bituminous membrane laid under the tiles, perspective cut through.

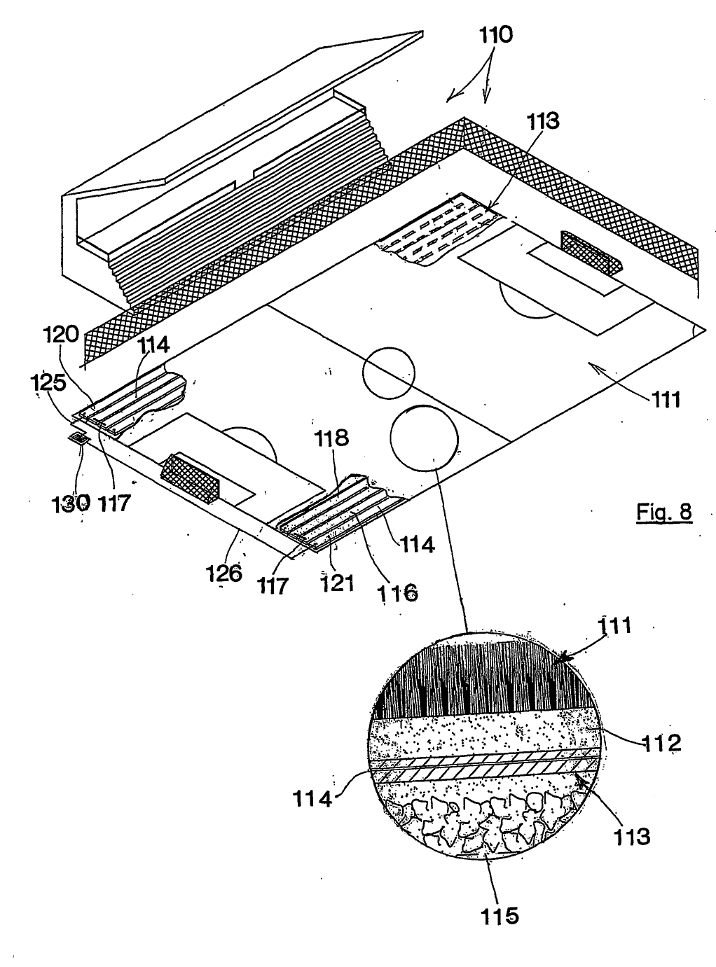

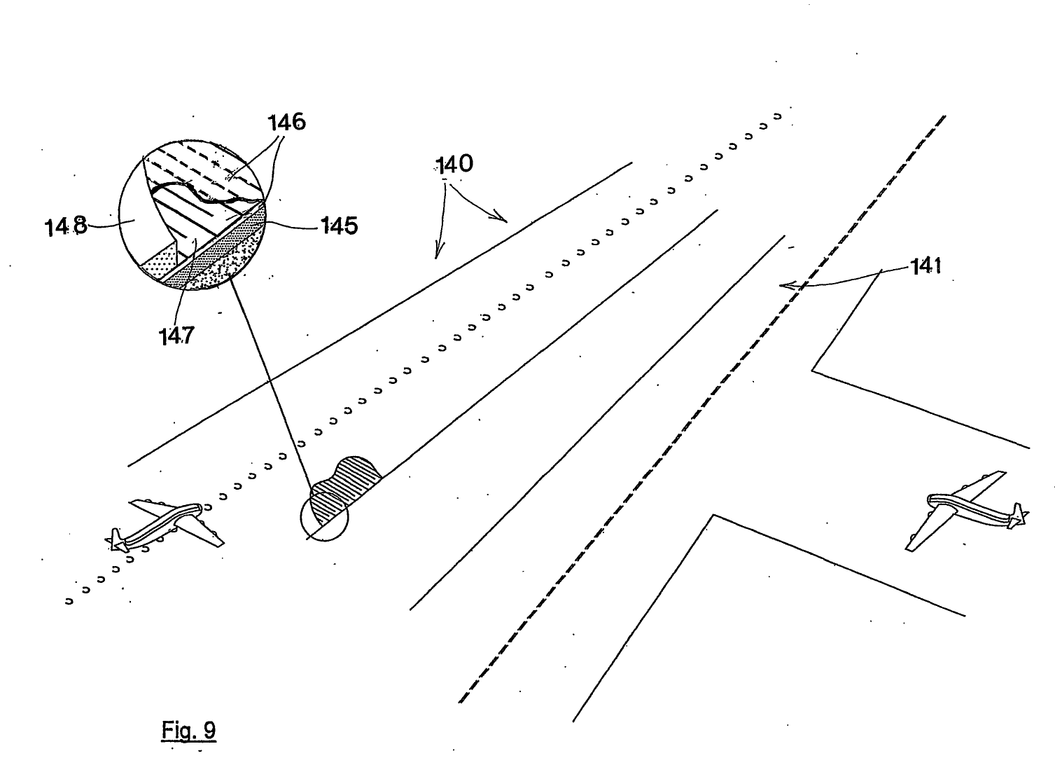

FIG. 8 A football field with the grassy surface electrically heated using the bituminous membrane, perspective with detail.

FIG. 9 An airport runway electrically heated using the bituminous membrane, perspective with detail.

The bituminous membrane 10, wound in strip form on the roll 11, presents (FIG. 1) an aluminium lamina core 12 laid as a continuous serpentine of a constant section, formed by a series of transversal cuts 13 through said lamina, extending to within a short distance from the edges 15 and 16 of the strip 10.

In a first alternative (FIG. 2) the bitumenous membrane 20 with its aluminium core 21 presents a series of cuts 22 made crosswise and alternatively through the whole thickness of the membrane to within a short distance of its respective edges 23 and 24.

In both membranes 10 and 20 connection can be made to a source of electric current, for example through the electrodes 30 and 31 of wires 26 and 27, fixed to the ends of the metal core 21, inserting them in holes 28 made in the surface 25 of the membrane 20.

In a second alternative (FIG. 3), the cuts 43 can be longitudinal in the membrane 40, that can be wound in a roll 41, with the metal core 55 seen in the break as drawn to form U-shaped pieces 50, 51.

Electric connections can obviously be made to the various elements of the membrane, either in series or in parallel.

FIG. 4 shows the metal cores 55 of elements 50 and 51 connected in series by means of the bridging wire 66.

Wires 64-66 are fixed to the electrodes 60 inserted in holes 61 made on the surface 58 of the U-shaped pieces 50, 51 of the membrane 40 to be joined to the core 55.

In FIG. 5 the metal cores 55 of elements 50-52 of the membrane are connected in parallel, by pairs of electrodes 70, 71, to wires 76, 77, and branch points 74, 75.

Electric power applied can be between 20 and 100 Watt m².

Thickness of the metal core can be 20-40 microns.

Voltage of from V 0.5 to 1 and current from A 20 to 100 can be applied to each one-metre length by one-metre width of metal core.

FIGS. 6-9 show some examples of the numerous possible applications of the invention.

FIG. 6 shows an indoor room 80 with flooring 81 under which is laid a base 82 of bituminous mambrane 20 with serpentinewise metal core 21.

The layer of mortar 63 and the tiles 64 are then laid over the membrane.

Electrodes 92 and 93 mounted at the ends 90, 91 of the serpentine are connected to the source of electric current by wires 97, 98 and the control box with regulator 95.

The room 80 can therefore be heated as desired at a very low cost.

FIG. 7 shows a roof 100 with tiles 101 laid on supporting planks 102 with the bituminous membrane 105 and metal core 106 between them. The ends of the core are connected by wires 107, 108 to the electric feed and regulating box 109.

On a roof thus heated, snow will not lie avoiding related serious consequences.

FIG. 8 shows a football field and a useful way not only of heating it but also of stimulating growth, fostering the good health of the plants in the grassy surface and keeping it in good condition.

Before the layer of earth 112 with plants 111 is laid on the field 110, the U-shaped components 113 of the bituminous membrane, complete with metal core 114 formed of components 116, 118, are laid all over the base 115.

The ends 120, 121 of said core 114 are respectively connected to wires 125, 126 that, when inside the interred chamber 130, receive electric current suitably programmed and regulated by a control unit not shown in the figure for simplicity.

The U-shaped components 116, 118 laid side by side, are series connected by electric bridges 117.

FIG. 9 illustrates an airport 140 with runway 141.

The bituminous membrane 146 with metal core 147 is laid over the base 145. The usual paving surface 148 of the runway is then laid over the membrane.

The fact that the serpentine is electrically heated prevents accumulation of snow which dissolves as soon as it falls so avoiding the very serious problems related to hindrance of air traffic as well as the cost of all the equipment at present needed for dealing with this emergency.

An efficient system of regulation and programming can be installed to adjust the supply of heat according to environmental conditions.

1. Membrane (10, 20, 40, 105, 113, 146) with metal core (12, 21, 55, 106, 114, 147) for waterproofing and generally protecting housing structures (80, 100) and infrastructures (110, 140), consisting of a single component (12, 21, 106) or of several (50-52, 116, 118), presents extremely high electric conductivity, parts or entire lengths of constant thickness and width to permit, by closure in an electric circuit of all parts of the core (12, 21, 55, 106, 114, 147), transformation of electric energy into thermal energy adding, to the effects of protection and waterproofing, generation of heat therefore associating a mechanical performance to that of producing heat.

2. Membrane (10, 20, 40, 105, 113, 146) as in claim 1,
characterized in that it is composed of bituminous material.

3. Membrane (10, 20, 40, 105, 113, 146) as in claim 2,
characterized in that the bituminous material is associated to plastomers.

4. Membrane (10, 20, 40, 105, 113, 146) as in claim 2,
characterized in that the bituminous material is associated to elastomers.

5. Membrane (10, 20, 40, 105, 113, 146) as in claim 1,
characterized in that the material of the metal core (12, 21, 55, 106, 114, 147) is copper.

6. Membrane (10, 20, 40, 105, 113, 146) as in claim 1,
characterized in that the material of the metal core (12, 21, 55, 106, 114, 147) is aluminium.

7. Membrane (20) as in claim 1,
characterized in that the core (12) is laid as a continuous serpentine so formed by means of parallel cuts (22) extending alternatively from one edge (15) to within a short distance from the opposite edge (16) of the membrane 20).

8. Membrane (10, 105, 113,146) as in claim 1,
characterized in that the core (12, 21, 106, 147) is laid as a continuous serpentine by means of parallel cuts (13) extending alternatively from one edge of the membrane to within a short distance from its opposite edge (12, 21,106, 147).

9. Bituminous membrane (10, 20, 105,113,146) as in claims 7, 8,
characterized in that the cuts (13, 22) are made transversally.

10. Membrane (40) as in claims 7, 8,
characterized in that the cuts (43) are made longitudinally.

11. Membrane (40, 113) as in claim 1,
characterized in that the various components (50-52, 114) are laid side by side to cover the area to be protected, and are connected in series or in parallel to the source of electric current.

12. Membrane (10, 20, 40, 105, 113, 146) as in claim 1,
characterized in that the metal core (12, 21, 55, 106, 114, 147) is connected to the source of electric current by a regulator (95) or electronic processor (109) in order to program and render automatic heating temperature levels and times as required by environmental conditions in one area of the membrane (10, 20, 40, 105, 113, 146) or in parts thereof.

13. Membrane (10, 20, 40, 105, 113, 140) as in claim 1,
characterized in that electrical connection to the metal core (12, 21, 55, 106, 114, 147) is made by using chemical and mechanical means to free points of electric contact in the material that covers said core.

14. Membrane (20) as in claim 1,
characterized in that it is laid under the surface flooring, of tiles (84) or any other material, of indoor rooms (80).

15. Membrane (146) as in claim 1,
characterized in that it is laid under the paving of runways (141) at airports (140).

16. Membrane (10, 20, 40, 105, 113, 146) as in claim 1,
characterized in that it is laid under road surfaces in the open or in tunnels.

17. Membrane (105) as in claim 1,
characterized in that it is laid underneath the tiles (101) and under the roofing (102) in general of buildings (100).

18. Membrane (113) as in claim 1,
characterized in that it is laid underneath the layer of earth containing plants (111) forming the grassy surface of football stadiums (110).

19. Membrane (10, 20, 40, 105, 113, 146) as in claim 1,
characterized in that it is between two and four millimeters thick.

20. Membrane as in claim 1,
characterized in that it is formed of rectangular components laid side by side and sufficiently spaced for electrical insulation.

21. Membrane (40, 113) as in claim 1,
characterized in that it is formed of U-shaped squared components (50-52) placed side by side and sufficiently spaced for electrical insulation.
